(19) United States
(12) Patent Application Publication
(10) Pub. No.: US 2009/0164821 A1
(43) Pub. Date: Jun. 25, 2009

(54) METHOD AND A SYSTEM FOR CONTROLLING A SLEEP MODE OF A DEVICE IN A WIRELESS COMMUNICATIONS NETWORK OR IN A MOBILE POINT-TO-POINT CONNECTION

(75) Inventor: Wolfram Drescher, Dresden (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/091,072

(22) PCT Filed: Oct. 10, 2006
(86) PCT No.: PCT/IB06/53867

§ 371 Date: Aug. 8, 2008

(30) Foreign Application Priority Data
Oct. 28, 2005 (EP) 05110137.6

(51) Int. Cl. G06F 1/32; G06F 1/12

(52) U.S. Cl. 713/323; 713/401

(57) ABSTRACT

The present invention relates to a method for controlling a sleep mode of a device in a wireless communications network or in a mobile point-to-point connection in order to turn off system components of the device, especially to turn off a medium access control (2) comprising the steps of: receiving a sleep mode information from an application module in a medium access control (2), coupled to an extended physical layer (PHY), especially to a base band (3), transferring the sleep mode information from the medium access control (2) to the base band (3), setting a sleep signal (sleep) of a power management mode (PMMode) to set one of the system components into sleep state, and, additionally, starting a predetermined first delay timer (T1) to delay the setting of the sleep state for one of the system components.

The present invention relates to a method and a system for controlling a sleep mode of a device in a wireless communications network or in a mobile point-to-point connection in order to turn off system components of the device, especially to turn off a medium access control, an radio frequency subsystem, a base band device, etc. The device could be a radio communications device (also called UWB transmitter, with UWB=ultra-wide band).

The very rapid progress of integrated circuit complexity has permitted an increase in the functionality, which can be included in a very compact device, such as in a mobile terminal or in an access point. However, power supply capabilities have not advanced that fast. Thus, in order to provide complex functionality in a small device, a very high degree of power management has become an enabling technology.

The standby or sleep mode of the device is used to reduce power consumption when one of the system components of the device is not required. Normally, when it is desired to put a system component into a sleep mode, this is done by setting the sleep state of the power management mode (=so called PMMode) and generating a disable signal for the subsystem clock of the medium access control (so called MAC) and activating the sleep clock or lazy clock (further called lazy clock) of the medium access control.

In a preferred case, the system clock is triggered by a system timer circuit which is part of the radio frequency subsystem. That means, the system timer circuit triggers the radio frequency subsystem as well as the medium access control. The system timer circuit normally runs with e.g. 66 MHz. Thus, the medium access control sets fast into the sleep mode. The lazy clock of the medium access control normally runs with e.g. 32 kHz. Consequently, the lazy clock could not be activated before the medium access control is already in the sleep mode. Hence, it could result in a loss of data.

Therefore, there is a need to provide a device using a sleep mode management wherein the above-mentioned disadvantage can be avoided.

In accordance with a first aspect of the present invention a method for controlling a sleep mode of a device in a wireless communications network or in a mobile point-to-point connection is provided in order to turn off system components of the device as claimed in claim 1.

In accordance with a second aspect of the present invention a system for controlling a sleep mode of a device in a wireless communications network or in a mobile point-to-point connection is provided in order to turn off system components of the device as claimed in claim 10.

In accordance with a third aspect of the present invention an extended physical layer for use in a wireless communications network or in a mobile point-to-point connection is provided in order to turn off system components of the device as claimed in claim 16.

The advantages of the present invention are a clean design because BB-RF serial Interface (with BB-RF=base band−radio frequency subsystem) is not shared for this specific sleep task. A BB-RF serial interface will not get started by a state machine of the base band anymore but exclusively by the BB-RF serial interface source register. Furthermore, a delay of the BB-RF serial interface must not be added to a transport of information. There is no data loss during the stepwise process to set the system components into the sleep state.

The key aspect of the present invention is to build a system which guarantees a wake-up from sleep applicable in devices, such as a mobile phone, a mobile computer, a mobile digital camera, without data loss. Given this task of the invention, a method for controlling the sleep mode of a device in a wireless communications network or in a mobile point-to-point connection in order to turn off system components of the device is suggested, wherein a predetermined first delay timer is additionally started to delay the setting of the sleep state for one of the system components. Before the setting of the sleep state is delayed, the information to enter the sleep mode is generated from an application module, connected to a medium access control (shortly called MAC), coupled to an extended physical layer (shortly called PHY), and is transferred from the medium access control to the extended physical layer. There, a sleep signal of a power management mode in the base band (also called BB) is generated to set one of the system components, e.g. the medium access control, the base band, the radio frequency subsystem (also called RF), into sleep state. To delay the setting of the sleep state of the relevant system component, e.g. the medium access control, the base band or the radio frequency subsystem, the set sleep signal starts the predetermined first delay timer.

In other words: The medium access control decides when the device or the system goes into sleep. During the process to go into sleep, different steps have to be processed for sending the device including its system components, such as a medium access control, the base band and the radio frequency subsystem, into sleep state.

While the medium access control is triggered from the radio frequency subsystem, the medium access control should be earlier set into the sleep mode than the physical layer. This ensures that no data loss will occur in the medium access control. The medium access control goes first into the sleep mode. The extended physical layer goes into the sleep mode after the expiration of the predetermined first delay timer. For this, a start-sleep signal is generated to set the sleep state of the extended physical layer and to stop a base band PLL, which generated the clock of the medium access control.

In a further embodiment of the invention, a stop clock signal is generated to stop the system clock of the medium access control. Furthermore, a lazy clock of the medium access control is started to guarantee the recognition of a system wake-up call. The stopping of the system clock as well as the switch to the lazy clock is done after the expiration of the predetermined first delay timer.

With respect to the high number of different devices and their base system, the first delay timer is individually set when booting up the device. For instance, the first delay time could be in a range from 0.05 μs to 5 μs.

For saving the data before the relevant system components go into the sleep mode, the single system components will be stepwise set into the sleep mode. For example, the radio frequency subsystem reaches the sleep mode after the base band is in the sleep mode. Therefore, a power down signal will be asserted, which set the radio frequency subsystem into the sleep state after the expiration of the predetermined first delay timer for the base band and after the expiration to a predetermined second delay time. This predetermined second delay timer is started to delay the sleep state of the radio frequency subsystem. It is started by the start-sleep signal of the first delay timer after the expiration of the predetermined first delay time.

To ensure that the base band goes earlier into the sleep mode and therefore, to prevent a data loss, the setting of the sleep state of the radio frequency subsystem and the stopping of a front-end PLL, which triggered the base band PLL of the base band, is done after the expiration of the predetermined second delay time.

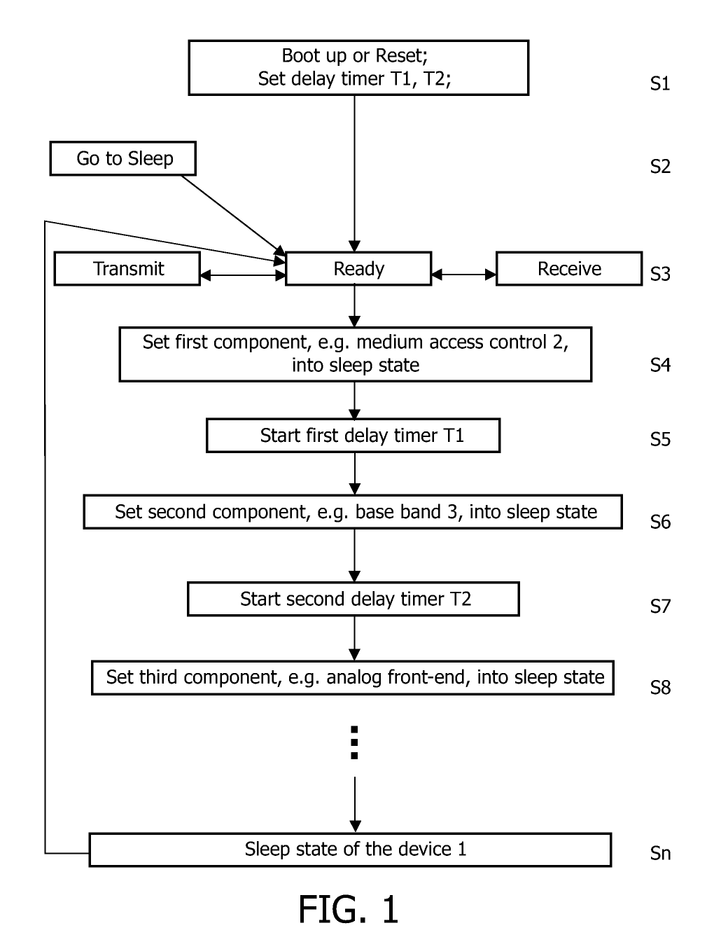

FIG. 1 shows a block schematic diagram of the method for controlling a sleep mode of a device in order to turn off system components of the device.

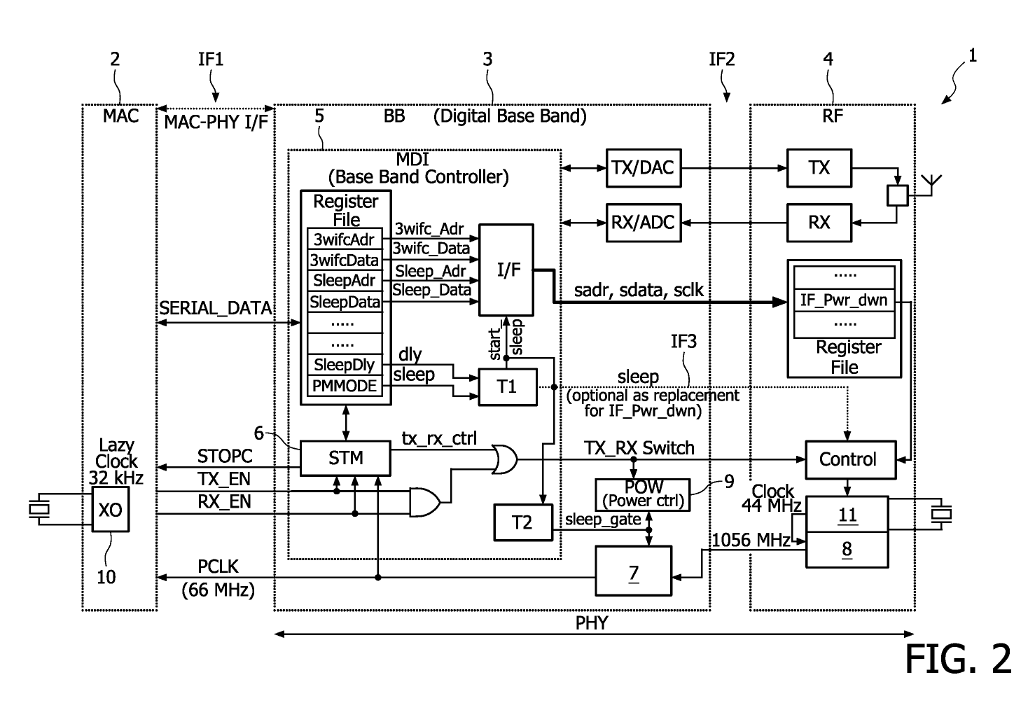

FIG. 2 shows a block schematic diagram of the architecture of the device with a medium access control, coupled via a base band to a radio frequency subsystem. The device may operate as a multi-mode communications device, e.g. as a UWB device.

FIG. 1 shows a block schematic diagram of the method for controlling a sleep mode of a device 1 in order to turn off a number of system components of the device 1.

In the presently preferred embodiment in a first step S1, the device 1 sets a number of parameters during a boot up routine or during a reset routine. For implementing an algorithm for the device 1 to go into sleep mode, also parameters for the algorithm of controlling the sleep mode of the device 1 are set during the boot routine or during the reset routine. For instance, a number of delay timers T1, T2 are set as parameters. For each system component 2 to 4, e.g. for a medium access control 2, a base band 3 and a radio frequency subsystem 4, a separate delay timer T1, T2 could be set.

An application module of the device 1 asserts a sleep mode information to a control device, e.g. to a medium access control 2 of the device, (see S2) during the normal working cycle “ready” of the device, e.g. during transmitting or receiving (see S3).

As a next step S4: A first system component, which is determined by the medium access control 2, runs into the sleep state. For instance, the medium access control 2 itself goes into the sleep mode at first. The first system component is synchronized by another system component, e.g. by a second system component, for instance by a PLL of the base band 3 (PLL=phase locked loop circuit). To ensure that no data loss will appear during the time it takes to reach the sleep state of the first system component, a first delay timer T1 is started in order to delay the setting of the sleep state of the second system component, e.g. of the base band 3, (see steps S5 and S6).

To setting the sleep state of the second system component, a second delay timer T2 is started to delay the setting of the sleep state of a third system component; e.g. of an radio frequency subsystem 4, which synchronized the second system component, e.g. the base band 3 (see steps S7 and S8).

The described routine to set a number of system components 2 to 4 of the device 1 into the sleep state with a predetermined delay time T1 and/or T2 is continued until all relevant system components 2 to 4 are in the sleep state.

FIG. 2 shows a preferred embodiment of the present invention for a UWB transmitter as a device 1.

The device 1 comprises a medium access control 2, which is coupled via a serial interface IF1 with a base band 3. The base band 3 is coupled via a BB-RF serial interface IF2 with a radio frequency subsystem 4. The base band 3 is a digital base band integrated circuit (shortly called BB-IC).

After reception of sleep mode information from an application module, e.g. a software application, of the device 1 the medium access control 2 decides when the device 1 goes into sleep. The steps, which have to be processed for sending the device 1 including the medium access control 2, the base band 3, integrated the base band controller 5, and the radio frequency subsystem 4 into sleep state are as follows:

TABLE 1

| | System clock | |
|---|---|---|
| Step | cycles PCLK | Algorithm of “set system component into sleep state” |
| 0 | — | Initial setup during boot up or reset: |
| | | set first delay timer “T1” with a predetermined delay time |
| | | “SleepDly” needed for the medium access control 2 to |
| | | switch to lazy clock after finishing step 2 (in system clock |
| | | cycles PCLK); |
| | | set address of power down signal “IF_Pwer_dwn” of the |
| | | radio frequency subsystem 4 for a BB-RF serial interface |
| | | access, located in the sleep mode information “SleepAdr”; |
| | | set value to put on the sleep mode information “SleepAdr” |
| | | via BB-RF serial interface access, located in the sleep mode |
| | | information “SleepData” |
| 1 | — | The medium access control 2 decides to send the device 1, |
| | | especially his system components 2, 3, 4 into sleep mode and |
| | | initializes a transfer to the physical layer PHY, especially to the |
| | | base band 3 via the serial interface IF1. |
| 2 | 14 | The medium access control 2 set the sleep flag of the power |
| | | management mode “PMMode” of the device 1. The state of the |
| | | transmitter “TX_EN” and of the receiver “RX_EN” are both low. A |
| | | state machine 6 of the base band 3 moves into state sleep. |
| 3 | SleepDly | The sleep signal “sleep”, which is equal with the value of the power |
| | | management mode “PMMode”, starts the first delay timer “T1”. The |
| | | first delay timer T1 starts counting from value “SleepDly” down to |
| | | 0. Optionally, the base band controller 5 of the base band 3 may |
| | | already stop the system clock of the medium access control 2 by |
| | | asserting the signal “STOPC”. |
| 4 | 18 | When the first delay timer T1 gets down to 0 it triggers a transfer of |
| | | the value of the sleep mode information “SleepData” via the second |
| | | interface IF2, a BB-RF serial interface, to the register file of the |
| | | radio frequency subsystem 4 with an address coming from the sleep |
| | | mode information “SleepAdr”. |
| | | In parallel, a second delay timer T2 is triggered in order to emulate |
| | | the transfer delay of the transfer of the sleep mode information and |
| | | the value via the second interface IF2. After the transfer via the |
| | | second interface IF2 was finished, the second delay timer T2 |
| | | disables the base band PLL 7 by deasserting the signal “slepp_gate”. |
| 5 | <1 | When the power down signal “IF_Pwr_dwn” in the radio frequency |
| | | subsystem 4 is set, the radio frequency subsystem 4 immediately |
| | | cuts off the radio frequency subsystem PLL 8, which synchronized |
| | | the base band 3, and the radio frequency subsystem 4 goes into |
| | | sleep state. |
| | | The base band 3 is now shot off by de-assertion of the signal |
| | | “sleep_gate” after the expiration of the second delay timer T2. The |
| | | signal “sleep_gate” is also used for enabling the power-down mode |
| | | of the power control module 9. |
| 6 | — | The system clock “PCLK” is turned off, until the medium access |
| | | control 2 returns by the help of its lazy clock 10 to an active state. |
| Sum | 32 PCLK + | |
| | SleepDly | |

Alternatively, the following option could be implemented in the algorithm to control the sleep mode of the device 1:

The information that the radio frequency subsystem 4 should enter into the sleep state is not passed via the second interface IF2, e.g. the BB-RF serial interface, but by a separate wire IF3. The transferred signal “sleep” via the separate wire IF3 is delayed by the first delay timer T1 as described in step 3 of table 1.

The advantages of the present invention are:
A clean design because the second interface IF2—the standard BB-RF serial I/F—is not shared for this specific task of the delay of running into the sleep mode. The second interface IF2 will not get started by the state machine 6 anymore but exclusively by the BB-RF serial I/F source register.
The delay of the second interface IF2 must not be added to transport of information.
The sleep mode information “SleepAdr” and “SleepData” will be saved in the register of the base band 3, in the so called vendor register.

The steps, which have to be processed for exit the device 1 including the medium access control 2, the physical layer PHY, integrated the base band 3, the base band controller 5, and the radio frequency subsystem 4, from the sleep state are as follows:

TABLE 2

| | System clock | |
|---|---|---|
| Step | cycles PCLK | Algorithm of “Exit system components from sleep state” |
| 0 | — | Initial setup not needed |
| 1 | — | The medium access control 2 running on lazy clock 10 decides to |
| | | wake up the device 1 from sleep and asserts the signals “TX_EN” |
| | | and “RX_EN” at the same time. |
| 2 | — | A combinatorial logic in the base band controller 5 of the base |
| | | band 3 detects this event and assert signal “TX_RX_Switch” to the |
| | | radio frequency subsystem 4. |
| 3 | WakeUpDelay | The radio frequency subsystem 4 detects assertion of the signal |
| | In 0.5 μs | “TX_RX_switch” and turns on the reference clock 11 for the base |
| | | band 3 with 44 MHz. |
| | | In addition, power module 9 turns up the voltage level for the base |
| | | band 3. |
| 4 | 1 | The base band PLL 7 receives a clock signal again and distributes |
| | | it to state machine 6. The state machine 6 continues operation by |
| | | going into the state “Standby”. |
| 5 | 1 | The state machine 6 clears the flag “Sleep” of the power |
| | | management mode “PMMode” and set the flag “Standby”. |
| 6 | 1 | The base band controller 5 continues delivering the system clock |
| | | signal “PCLK” to the medium access control 2. |
| Sum | 3 PCLK + | |
| | WakeUpDly | |

In summary, all three system components—the medium access control 2, the base band 3 and the radio frequency subsystem 4—of the device 1 are involved, when the device 1 is sent to sleep state.

Preferably existing interfaces, such as the serial interface IF1 and the BB-RF serial interface IF2 will be used. The serial interface IF1 is used for the communication between the medium access control 2 and the physical layer PHY, especially the base band 3. The BB-RF serial interface IF2 is used for the communication between the base band 3 and the radio frequency subsystem 4. Optionally, a direct connection via a separate wire IF3 may replace the usage of the BB-RF serial interface IF2 when the base band 3 sends the sleep message to the radio frequency subsystem 4.

The first delay timer T1 delays the event by a predetermined delay time “SleepDly” when the flag “SLEEP” in the power management mode “PMMode” is set. This should ensured that the medium access control 2 has enough time to go into the sleep state and switch to run on the lazy clock 10.

A further delay timer T2 emulates the delay of a transfer operation via the second interface IF2, e.g. the BB-RF serial interface. After this second delay timer T2 assured that the last transferred bit left the base band 3 its output signal “sleep-gate” is used for the following two purposes. At first, it stops the generation of the internal base band PLL 7. At second, it asserts the power down state to the power unit 9. Hence, the signal “sleep-gate” should be active “Low”.

The device 1 returns from sleep state when the signals “RX_EN” and “TX_EN” via the first interface IF1 will be active simultaneously.

A combinatorial logic detects this state and sets signal “TX_RX_Switch” via the second interface IF2 to “High”. The same signal “TX_RX_Switch” turns on the power module 9 again. It has to be clearly designed, because the logic connection of the signal “TX_RX_Switch” is used during normal operation concurrently.

The radio frequency subsystem 4 recognizes this signal “TX_RX_Switch” and turns on its PLL 8, which synchronized the base band PLL 7. The radio frequency subsystem 4 is also starting to run the reference clock 11 with 44 MHz.

The base band PLL 7 then generates the 66 MHz internal clock, which synchronized the system clock with the signal “PCLK”.

The base band controller 5 recognizes the internal signal “Exit_from_sleep” and the state machine 6 goes to state “Standby”. The state machine 6 clears the flag “Sleep” of the power management mode “PMMode” and set the flag “Standby”.

The present invention is described with particular reference to the presently preferred embodiments. However, it should be understood that these embodiments are only examples of the many advantageous uses of the innovative teachings herein.

### LIST OF REFERENCE NUMERALS

1 Device
2 medium access control (MAC)
3 base band (BB)
4 radio frequency subsystem (RF)
5 base band controller (MDI)
6 state machine (STM)
7 base band PLL (CGM-PLL)
8 front-end PLL (PLL)
9 power module (POW)
10 lazy clock (Lazy Clock)
11 reference clock (XO)
   IF1 first interface (serial interface or MAC-PHY-interface)
   IF2 second interface (BB-RF serial interface or PHY-RF-interface)
   PHY physical layer
   T1 predetermined first delay timer
   T2 predetermined second delay timer

1. A method for controlling a sleep mode of a device in a wireless communications network or in a mobile point-to-point connection in order to turn off system components of the device, especially to turn off a medium access control comprising the steps of:
receiving a sleep mode information from an application module in a medium access control, coupled to an base band,
transferring the sleep mode information from the medium access control to the base band,
setting a sleep signal of a power management mode to set one of the system components into sleep state, and,
additionally, starting a predetermined first delay timer to delay the setting of the sleep state for one of the system components.

2. The Method of claim 1, wherein the sleep signal starts the predetermined first delay timer.

3. The method of claim 1, wherein, after the expiration of the predetermined first delay timer, a start-sleep signal is generated to set the sleep state of the extended physical layer and to stop a system timer circuit, which synchronized the clock of the medium access control.

4. The method of claim 1, wherein, after the expiration of the predetermined first delay timer, a stop clock signal is generated to stop the clock of the medium access control and a lazy clock is started to hold the medium access control in the sleep state.

5. The method of claim 1, wherein the first delay timer is setting when boot up the device.

6. The method of claim 1, wherein, after the expiration of the predetermined first delay timer, a power down signal is generated to set a radio frequency subsystem, coupled to the base band, into a sleep state.

7. The method of claim 6, wherein a predetermined second delay timer is started to delay the sleep state of the radio frequency subsystem.

8. The method of claim 7, wherein, after the expiration of the predetermined first delay timer, the start-sleep signal starts the predetermined second delay timer.

9. The method of claim 7, wherein, after the expiration of the predetermined second delay timer a sleep gate signal is generated to set the sleep state of the radio frequency subsystem and to stop a front-end PLL, which synchronized the base band PLL of the base band.

10. A system for controlling a sleep mode of a device in a wireless communications network or in a mobile point-to-point connection in order to turn off system components of the device, especially to turn off a medium access control comprising:
a medium access control, which receives a sleep mode information from an application module and is coupled to an base band and transfers the sleep mode information via an first interface to the base band,
the base band, which generates a sleep signal of a power management mode to set one of the system components into sleep state, and,
a predetermined first delay timer to delay the setting of the sleep state for one of the system components.

11. The system of claim 10, wherein, a base band PLL, which synchronized the system clock with the clock signal of the medium access control, is stopped after the expiration of the predetermined first delay timer.

12. The system of claim 10, wherein the clock of the medium access control is stopped and their lazy clock is started after the expiration of the predetermined first delay timer.

13. The system of claim 10, wherein a radio frequency subsystem, coupled to the base band, is set into sleep state after the expiration of the predetermined first delay timer.

14. The system of claim 13, wherein a predetermined second delay timer is started to further delay the sleep state of the radio frequency subsystem.

15. The system of claim 14, wherein a front-end PLL, which synchronized the base band PLL of the base band is stopped after the expiration of the predetermined second delay timer.

16. An extended physical layer for use in a wireless communications network or in a mobile point-to-point connection, being capable of receiving sleep signals to turn off system components of a device from a medium access control during a working mode, and setting a sleep signal of a power management mode to set one of the system components into sleep state and, additionally, starting a predetermined first delay time to delay the setting of the sleep state for the relevant system component.
